(19) United States
(12) Patent Application Publication
(10) Pub. No.: US 2006/0282527 A1
(43) Pub. Date: Dec. 14, 2006

(54) System for very simple network management (VSNM)

(75) Inventors: Cheng-Mau Chiou, Hsinchu (TW); Mark Wingrove, Prestwood (GB); Philip Crooks, St. Albans (GB); Iain Robertson Kenney, Hempstead (GB); Adrian Keith Pearce, St. Albans (GB); David Kind, St. Albans (GB); James Freeman, Buzzard (GB); Brian Metters, Westoning (GB)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Accton Technology Corporation

(21) Appl. No.: 11/150,915

(22) Filed: Jun. 13, 2005

(51) Int. Cl. G06F 15/173

(52) U.S. Cl. 709/224

(57) ABSTRACT

The present invention discloses a system for very simple network management (VSNM), comprising an information database to store or collect various data. An AI (artificial intelligent) engine is coupled to the information data base. A knowledge base rule database is used for storing knowledge base rule and is coupled to the information database and the AI engine. A webpage generator is coupled to the knowledge base rule database and the AI engine. A user interface is coupled to the AI engine. A web server is coupled to the user interface and the webpage generator.

### FIELD OF THE INVENTION

The present invention relates to network management, more particular, to a very simple network management.

### BACKGROUND OF THE INVENTION

Computer networks have become increasingly complex while people have relied on computers coupled to the networks to transmit and fetch information. The computer networks are responsible for transporting information between the computers used in the business as well as allowing users to connect to their work from remote locations. Network management systems have been developed to assist in managing computer networks. Technology and businesses are constantly seeking ways to improve the efficiency and reduce information technology (IT) costs. This has given rise to an increasing number of outsourcing service providers to deliver reliable service while offloading the costly burdens of maintaining an IT organization. IT solutions require management that includes network connectivity, server maintenance, and application management in order to succeed.

Network management systems often need to support large networks and be capable of scaling up from managing a few devices on a network to a few thousand or more devices on a network while maintaining consistent performance and reliability. Typically, network management systems are tested for scaleability, performance, and reliability both before and after deployment. The Simple Network Management Protocol (SNMP) was originally developed in 1988 for internet management. One of its main goals was to provide a simple design that would facilitate its widespread and rapid deployment. SNMP has several other advantages between the management architecture and the hardware device architectures. Network management systems such as SNMP typically have two primary elements, a manager and agents. Managers are also referred to as applications. These managers contain software that runs on a network management station, such as a PC or workstation. The manager software implements the protocols used to exchange data with the network agents. The managers send out queries to gather information about the status, configuration and performance, as well as other parameters of external devices.

The following present invention illustrates a “very simple network management” (VSNM) for a class of user that would not use conventional SNMP and a supporting management application. This user will typically come from the Financial, Insurance, Real Estate (FIRE) or Education vertical markets, or similar generic small business. There will be typically less than 100 active devices on the network. There will not be a full time IT person in this organization so the knowledge in the organization with respect to networking will be small. Provided the application and system can be made intuitive, the dependence on a tool to help administer and keep the network running will be high. We can also assume that the network size does not justify it being segmented into subnets so VSNM applies to management within a subnet where the application resides.

### SUMMARY OF THE INVENTION

The purpose of the present invention is to provide an very simple network management without the usage of the conventional SNMP and a supporting management application.

The concept carries the potential for repeat purchases for the VAR or SI as the system will encourage contact and support from the user to the VAR/SI or conversely the system enables the VAR/SI to offer the user a value added service. In these cases the value of the VAR/SI is enhanced over more typical purchases. Provided the additional service opportunity provides additional revenues or opportunities for additional revenues then the VAR/SI is more likely to lead with a product carrying this feature set over one that does not. There is a value chain starting from the VAR or SI that encourages a close relationship with the end user such that the VAR or SI may achieve repeat business or secure revenue through the provision of services or expansion of the network. This will encourage the VAR/SI to go back to the supplier for more products. If the concept is successful then additional devices can be added into the network to support the concept further. For intelligent devices the additional cost will be negligible, however there are many things that can be achieved, they all will add some level of cost. Cost to the manufacturer must be the dominant consideration in the selection of what needs supporting balanced against the value it delivers in the eyes of VAR/SI and end user.

The present invention discloses a system for very simple network management (VSNM), comprising an information database to store or collect various data; an AI (artificial intelligent) engine coupled to the information data base; a knowledge base rule database for storing knowledge base rule and coupled to the information database and the AI engine; a webpage generator coupled to the knowledge base rule database and the AI engine; a user interface coupled to the AI engine; wherein a user may submit a query by means of user's terminal via the user interface; and a web server coupled to the user interface and the webpage generator. The data in the information database is collected from the intelligent devices on the network. The information database includes information selected from the group: basic information about the network, MAC address resolution, IP Address, MAC statistics, Physical layer information, Full/Half duplex, Rate, encrypted password depository, wireless statistics, channel, Encryption type and keys, blocked MAC addresses, Firewall status and the combination thereof. The knowledge base rule is used to provide guidance on what to do if a condition is detected.

The present invention discloses a protocol architectural for very simple network management (VSNM), comprising: a VSNM presentation layer allowing a user to access the information and the functionality; a VSNM function layer below the presentation layer for performing tasks in response to requests from the user via the presentation layer; and a VSNMP (Very Simple Network Management Protocol) and a VSNM Broadcast below the VSNM Function layer, wherein the VSNM Broadcast employed to provide communications to circumvent problems with IP address configuration, the VSNMP being used to collect statistics and allow network devices to report events. A SNMP is provided to communicate with legacy devices while communication with PCs. A SSL layer is below the VSNM Function layer. A TCP layer is below the SSL layer and UDP layer below the SNMP. A IP layer is underlying the UDP and the TCP. The VSNMP is TBD to collect statistics and allow network devices to report events.

### BRIEF DESCRIPTION OF THE DRAWINGS

FIG. 1 illustrates a diagram of the system for the VSNM according to the present invention.

FIG. 2 illustrates a diagram of the network example according to the present invention.

FIG. 3 illustrates a diagram of the protocol structure for the VSNM according to the present invention.

### DETAILED DESCRIPTION OF THE PREFERRED EMBODIMENT

The present invention provides a method and means for providing device testing. The present invention provides a novel system that allows improving the equipment utilization.

VSNM (Very Simple Network Management) is targeted at novice network administrators to ensure that they can keep their network healthy. An analysis of the support calls for the analysis for support for such products shows us that the complexity of a product increases the number of support calls that will be received. This is quite logical but a notable exception occurs when a product is so specialized that it would only ever be purchased and installed by someone who knew exactly what they were buying i.e. an “expert”. Even unmanaged switches can generate a significant number of support calls when they support optional hardware modules. To reduce these support calls we have to provide the user with the expertise required to understand their options. This can only be done by educating them via the user documentation or some other—easy to digest—medium. Experience tells us that users tend not to read documentation so other approaches have to be employed to ensure that the number of support calls drop. The majority of the problems faced by users occur during initial installation and configuration of the product. However, as the installed network becomes larger and more complicated, the user/administrator will experience more and more problems associated with network connectivity and topology. VSNM must address all these problems for all classes of product if it is to have maximum benefit for the users/administrators.

Very Simple Network Management Architecture

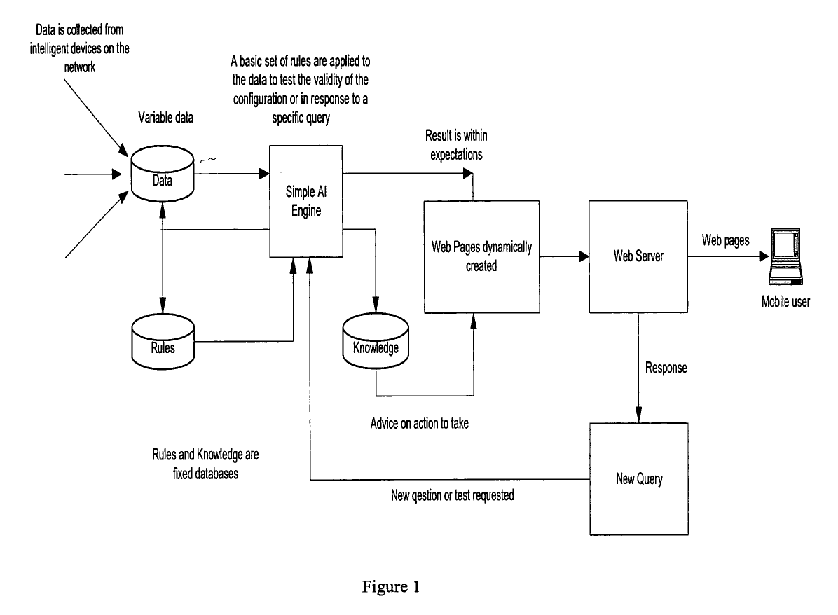

FIG. 1 shows the diagram of the Very Simple Network Management System. The system includes an Information Database to store or collect various data. In one embodiment, the knowledge database will be created from prior data. It will describe, in terms appropriate for the AI engine, what network problems look like. For instance, the data could be collected from the intelligent devices on the network. The database would contain basic information about the network, such as which devices are connected to what ports, which ports are effectively major trunks or backbones on the network, MAC address resolution, IP Address, MAC statistics, Physical layer information such as link status, Full/Half duplex, Rate, The information may also includes encrypted password repository for all devices on the network, wireless statistics such as SSID, channel, Encryption type and keys, blocked MAC addresses, Firewall status. The information could also be provided to a trusted VAR or SI to enable remote diagnosis and advice. What we are not trying to do is offer the sophistication or depth offered by SNMP, what we are trying to do is offer some clues that a problem is present, may be present, or likely to occur. The user is provided with information to check out the device proactively rather than wait for a problem to occur.

The data base is coupled to an AI (artificial intelligent) engine. Knowledge base rule could be stored in a Knowledge base rule database that is coupled to the information database as well as the AI engine. The knowledge base rule is used to provide guidance on what to do if a condition is detected. The knowledge base effectively is providing some of the information a skilled IT manager might provide, although in our application space a skilled network manager may not exist. The information base will be collected from the devices on the network. Central to this will be the intelligent switch which can tell VSNM which MAC addresses appear on which ports. This will allow a network topology to be built up showing the devices on the network and the interconnections between those devices. Further to this, VSNM will detect events on the network (or will have the events reported by the network devices) and will record these events in the information base.

A knowledge database is connected to the AI engine. A webpage generator is coupled to the knowledge database and the AI engine. User interface is coupled to the AI engine. One user may submit a query by means of the user's terminal via the user interface. A web server is coupled to the User interface and the webpage generator. In the embodiment, the AI engine will interpret the information in the information database using the “rules” or “knowledge” in the knowledge database. It will be able to infer, for example, that a printer connected to a heavily loaded switch may be difficult to access so users may experience lost print jobs or long delays and this information could be reported to the administrator along with recommendations for network reconfiguration.

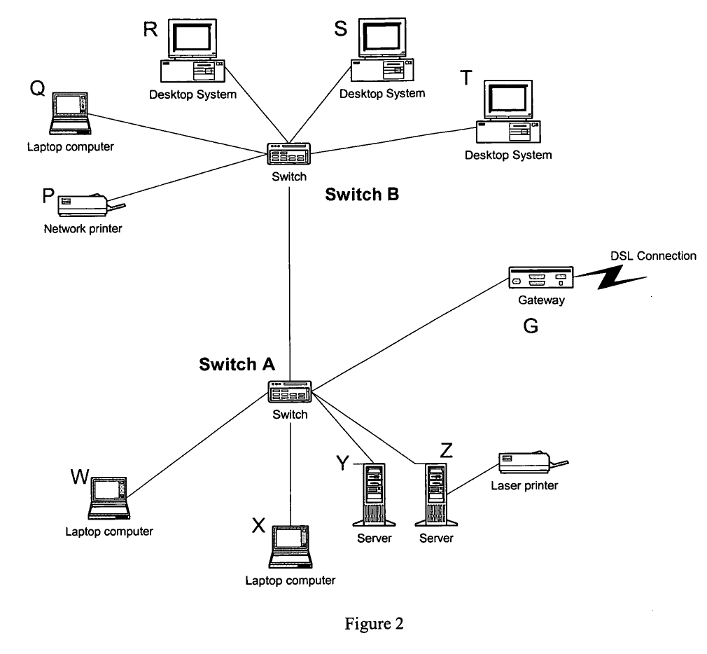

FIG. 2 shows the diagram illustrating an example of a simple network consisting of several clients, some desktop based and some laptop based. These are connected through two switches, and a small backbone to two servers. The network has a network attached printer, and a printer attached to a server. The connection to the WAN is based on a gateway device and firewall. The firewall effectively hides the presence of the networked devices through the use of NAT. The key is to list a set of common problems and establish some information to assist a user in identifying the root cause and resolving the problem.

The information stored in the knowledge database is created based on the knowledge base rule in view of the information database. When a query from the remote client via the user interface, the query will be sent to the AI engine. The AI engine will identify the query and search the associated answer for the query from the knowledge base rule database. The webpage with the information fetched from the knowledge base rule database will be generated by the webpage generator. Then the webpage will be send to the user.

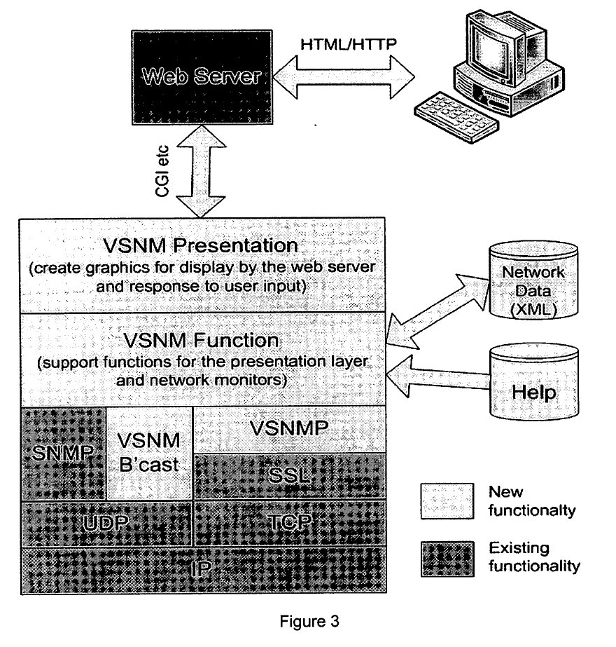

Please turn to FIG. 3, from the top of the diagram, the web server is provided. With the web server in place, the use of HTML and HTTP is obvious, as is the use of CGI to talk to the server-side functionality. The use of a web server will also support remote administration. The VSNM Presentation layer will create the topology map as well has handling the user interactions with the HTML pages. The presentation layer will allow the user to access the information and the functionality. The VSNM Function layer below the presentation layer will perform tasks in response to requests from the user (via the presentation layer) as well as performing routine tasks like statistics collection and checking for updated drivers. The Function Layer will also be responsible for access to data held on disk.

Two new protocols sit below the function layer; VSNMP (Very Simple Network Management Protocol) and VSNM Broadcast. VSNM Broadcast (this is a working title that could be changed) will provide communications at layer 2 to circumvent problems with IP address configuration. VSNMP is still TBD but will be used to collect statistics and will allow network devices to report events. SNMP will be used to communicate with legacy devices while communication with PCs and other, powerful network devices will use SSL (communication with devices that cannot support encryption will bypass the SSL layer). The layer below the SSL is TCP layer, and the layer below the SNMP is the UDP layer. The bottom layer underlying the UDP and the TCP is the IP layer. The following description is for the aspect of the present invention. The IP, UDP and TCP are well known in the art, therefore, the description is omitted.

Presentation Layer

All functionality will hinge on the network topology diagram. The top level diagram will give an indication of the status of devices and will allow the user to click on an individual device to find out more information and perform tasks on those devices. The network devices and interconnections will be automatically discovered (by the function layer) but auto-layout of diagrams is not easy and is unlikely to result in a clear diagram. There will be a need for a diagram editor which can move devices around on the page. User interaction with the html page (a) is still to be defined but, to meet the requirements, the user must be able to select a network device and perform one of the following actions:

Backup of configuration data

Restore configuration data (not necessarily to the same device that it came from but it must be same model)

Upload new firmware to the device

View an inventory of the devices connected to (or internal to) a PC

Launch the web interface of a network device. Login should be automatic using usernames and passwords saved on server

View statistics and configuration information associated with the device.

Functions can also be applied to the entire network e.g. discover new devices. The incremental addition of new devices to the topology diagram will need careful thought. Note that the layered nature of this architecture means that the presentation layer can be updated independently of the functionality provided by the VSNM.

Function Layer

As well as responding to user requests, the function layer will poll the network to determine its status. If the function layer detects a problem with the network, it will be flagged to the presentation layer which will amend the display. The function layer will hold a record of all the data recorded from the network. For maximum portability, the data will be held in XML format using a defined schema. It is this XML data that will be used by the presentation layer to create the network topology diagram. The function layer will respond to VSNM echo requests from other devices on the network.

Protocol Layer

VSNMP and VSNM Broadcast are new protocols. VSNMP is not yet defined but will require functionality similar to SNMP i. e. the ability to retrieve any piece of information from the network device. SNMP has the advantage that it is simple, low bandwidth (it uses UDP rather than TCP) and encodes data using ASN.1 (which means data is transferred in a binary format). In addition SNMP MIBs are well defined so data structures and access methods require little thought. Add to this the fact that SNMP has to exist in the VSNM server to support legacy, managed switches and basing VSNMP on SNMP makes a lot of sense.

VSNMP and VSNM Broadcast Protocol

The VSNMI (Very Simple Network Management Interface) requires a protocol to transmit and receive the data required by the VSNM network. For the sake of discussion, this protocol will be called VSNMP (Very Simple Network Management Protocol). It is tempting to consider the long-established and similarly named, SNMP protocol for this task; it unquestionably works and makes efficient use of network bandwidth. However, it requires ASN.1 encoding of transmitted data and Object Identifiers—used to address data—are difficult to interpret due to the extensive structure of the MIB. There are three different versions of SNMP; version 1, version 2c and version 3. Version 2c adds functionality to version 1. In particular, version 2c adds the getbulk method to allow large “chunks” of data to be down loaded with a single request. The version 2 standard originally included security mechanisms but agreement could not be reached so the security mechanisms were dropped and v2c—which uses version 1 security mechanisms—became the deployed standard. It was left to version 3 to add security mechanisms to SNMP; SNMPv3 is SNMPv2 plus security and administration.

SNMPv3 adds a wrapper around SNMPv2c (or SNMPv1); the original SNMP packet is encrypted and a new header is added. However the underlying protocol is unchanged—the same requests and responses are still used and it is still built on the use of UDP. We can safely discount SNMPv3 as a basis for VSNMP.

If SNMP is discounted because of its reliance on UDP transfers, it would be replaced. XML-RPC (extensible Markup Language—Remote Procedure Call) is one possibility. XML-RPC is transferred over HTTP so SSL can easily be used to encrypt as required. As protocols go, XML-RPC is even simpler than SNMP; it is text-based so requires no ASN.1 encoding. Base64 encoding is as complex as XML-RPC allows. While this has its advantages, it does mean that XML-RPC uses more network bandwidth than SNMP. In XML-RPC's favour, it is nothing more than a framework for defining remote procedure calls so can go significantly more than requesting data; it could be used to request that a device upgrades its firmware by passing in the URL of a firmware image or it could pass in the entirety of a configuration file.

VSNM requires an accurate picture of the network topology. To support this, the switch will be able to (1) provide a list of the MAC addresses that are accessible per port (2) provide the settings associated with the port e.g. speed and duplex (3) raise an event when a new MAC address is learned on a port or a MAC address ages out (4) raise an event when the link state changes for any port (e.g. a port loses link). To allow VSNM to find network bottlenecks and other performance issues the switch will be able to provide throughput measurements per port. The system will periodically interrogate devices on the network and collect statistics from them. The information will be stored in a central information database as shown in FIG. 1. The VSNM Server will collect essential information only. VSNM will not replicate large, standards-based MIBs. For example, the VSNM will support two different types of communication: Request/Response and asynchronous “events”. The VSNM Server will register with a client PC or network device to receive specific events. The application will carry three separate data sources: (1) Data collected from network devices; switches, gateways, APs, clients etc. (2) General information and knowledge about networking, essentially a general resource available to users providing advice and answers to commonly asked questions. (3) A knowledge base of fault finding steps to isolate and resolve a fault. This will need to check the data collected from devices and analyze these, and also use the general information database to advise the user on what steps to take if the fault cannot be resolved. As far as possible the actual steps and tests should be hidden from the user.

In the present invention, an automatically generated network topology map will be created. The map will show the user where in the network, problems have occurred. The network devices shown on the map will be interactive and will support operations e.g. password management, and device backup. The system will assist in the following areas: (1) Network Health Check; the application examines the database and checks that the network is not showing high error rates. It also checks for problems like duplex mismatch and speed optimization, bottlenecks on major routes through the network. These are things which can affect a networks performance, yet may not be immediately visible to the end user. (2) Backup and management of configuration data for each device. Where a device is removed from a network due to problem it should be possible to restore the old configuration into the new device automatically. It should also be possible to install a new, additional device by cloning existing information. (3) Check for updated drivers/firmware for devices that appear on the network. When new drivers become available, the user will be notified. It will be possible to install software on network devices. Assistance will be provided for PC installation. (4) Inventory management; what devices are attached to the network and what do they contain. Develop a database that represents an inventory of IT assets. (5) Password management. (6) Trouble shooting wizard: A set of pages that assist a user in diagnosing and resolving a problem.

It will be appreciated that the preferred embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

What is claimed is:

1. A system for very simple network management (VSNM), comprising:
an information database to store or collect various data;
an AI (artificial intelligent) engine coupled to said information data base;
a knowledge base rule database for storing knowledge base rule and coupled to said information database and said AI engine;
a webpage generator coupled to said knowledge base rule database and said AI engine;
a user interface coupled to said AI engine; wherein a user may submit a query by means of user's terminal via said user interface; and
a web server coupled to said user interface and said webpage generator.

2. The system of claim 1, wherein said data in said information database is collected from the intelligent devices on the network.

3. The system of claim 1, wherein said information database includes information selected from the group: basic information about the network, MAC address resolution, IP Address, MAC statistics.

4. The system of claim 1, wherein said information database includes information selected from the group: Physical layer information, Full/Half duplex, Rate.

5. The system of claim 1, wherein said information database includes information selected from the group: encrypted password repositoryy, Encryption type and keys, blocked MAC addresses.

6. The system of claim 1, wherein said information database includes information selected from the group: wireless statistics, channel, Firewall status.

7. The system of claim 1, wherein said knowledge base rule is used to provide guidance on what to do if a condition is detected.

8. A protocol architectural for very simple network management (VSNM), comprising:
a VSNM presentation layer allowing a user to access the information and the functionality;
a VSNM function layer below said presentation layer for performing tasks in response to requests from the user via said presentation layer; and
a VSNMP (Very Simple Network Management Protocol) and a VSNM Broadcast below said VSNM Function layer, wherein said VSNM Broadcast employed to provide communications to circumvent problems with IP address configuration, said VSNMP being used to collect statistics and allow network devices to report events.

9. The protocol architectural of claim 8, further comprising a SNMP to communicate with legacy devices while communication with PCs.

10. The protocol architectural of claim 8, further comprising a SSL layer below the VSNM Function layer.

11. The protocol architectural of claim 10, further comprising a TCP layer below said SSL layer and UDP layer below said SNMP.

12. The protocol architectural of claim 12, further comprising a IP layer underlying said UDP and said TCP.

13. The protocol architectural of claim 8, wherein said VSNMP is TBD to collect statistics and allow network devices to report events.
